(19) United States
(12) Patent Application Publication
(10) Pub. No.: US 2011/0049745 A1
(43) Pub. Date: Mar. 3, 2011

(54) MANUFACTURING METHOD FOR SOLID ELECTROLYTE SHEET

(75) Inventors: Yukihisa Katayama, Nagoya-shi (JP); Shigenori Hama, Susono-shi (JP); Takeshi Yanagihara, Miyoshi-shi (JP); Mitsuhiko Hayashi, Kani-shi (JP)

(73) Assignee: TOYOTA JIDOSHA KABUSHIKI KAISHA, Toyota-shi (JP)

(21) Appl. No.: 12/872,175

(22) Filed: Aug. 31, 2010

(30) Foreign Application Priority Data
Aug. 31, 2009 (JP) 2009-200380

(51) Int. Cl. B29C 35/06

(52) U.S. Cl. 264/104

(57) ABSTRACT

A manufacturing method for a solid electrolyte sheet includes applying slurry, which contains sulfide-based solid electrolyte powder, a sulfur-containing compound and a solvent, onto a base; and forming the slurry into a sheet.

### INCORPORATION BY REFERENCE

The disclosure of Japanese Patent Application No. 2009-200380 filed on Aug. 31, 2009 including the specification, drawings and abstract is incorporated herein by reference in its entirety.

### BACKGROUND OF THE INVENTION

1. Field of the Invention

The invention relates to a manufacturing method for a solid electrolyte sheet and, more particularly, to a manufacturing method for a solid electrolyte sheet, which is able to produce a homogeneous solid electrolyte sheet having a high ion conductivity with excellent productivity.

2. Description of the Related Art

With a rapid proliferation of information-related equipment and communication equipment, such as personal computers, camcorders and cellular phones, in recent years, it becomes important to develop a battery as a power source of the information-related equipment or the communication equipment. In addition, in automobile industry as well, development of a high-power and high-capacity battery used for electric vehicles or hybrid vehicles has been proceeding. Among various secondary batteries, a lithium secondary battery becomes a focus of attention because of its high energy density and output. Then, in order to further improve the performance, development of an all-solid lithium secondary battery that uses a solid electrolyte, such as an ion-conducting polymer and ceramic, as an electrolyte has been proceeding. A sulfide-based electrolyte becomes a focus of attention as ceramic that is useable as a lithium-ion-conducting solid electrolyte because of a high lithium ion conductivity.

An all-solid lithium secondary battery generally includes a positive electrode layer, a negative electrode layer and a solid electrolyte layer arranged between these electrode layers. The positive electrode layer and the negative electrode layer each generally contain a solid electrolyte for ensuring ion conductivity in addition to an electrode active material. In addition, the solid electrolyte layer, where necessary, contains a binding agent, or the like, for imparting flexibility in addition to the solid electrolyte.

An example of a manufacturing method for a solid electrolyte sheet may be the following method. First, a solvent is, where necessary, added to lithium sulfide (Li₂S) and phosphorus sulfide (P₂S₅), which is the raw material of solid electrolyte glass powder, and then the mixture is subjected to mechanical milling to thereby obtain Li₂S—P₂S₅ mixture powder (solid electrolyte glass powder). When a solvent is used in the mechanical milling, the mixture is dried to remove the solvent, and then the obtained Li₂S—P₂S₅ mixture powder is subjected to heat treatment to crystallize part of the mixture powder to thereby obtain crystallized Li₂S—P₂S₅ glass (solid electrolyte crystallized glass). Subsequently, the Li₂S—P₂S₅ mixture powder (solid electrolyte glass powder) or the crystallized Li₂S—P₂S₅ glass (solid electrolyte crystallized glass) is used to form a solid electrolyte sheet.

In addition, Japanese Patent Application Publication No. 2008-124011 (JP-A-2008-124011) describes that a crystalline solid electrolyte sheet having an excellent lithium ion conductivity may be obtained by means of a manufacturing method in which solid electrolyte glass powder made of Li₂S and P₂S₅ is molded into a sheet by pressing, or the like, and is subjected to heat treatment after or while the solid electrolyte glass powder is molded into a sheet.

However, JP-A-2008-124011 just describes that solid electrolyte powder is molded into a sheet by pressing. The solid electrolyte sheet has poor flexibility and machinability, and it is considerably difficult to mold a large area thin film (having a thickness of less than 100 μm). Furthermore, press molding is performed by batch treatment, so it may be difficult to perform continuous production.

In addition, in a manufacturing method for a solid electrolyte sheet, in which electrolyte slurry is applied onto a base, continuous production is possible; however, the sulfide-based electrolyte cannot be used because it reacts with water or a polar solvent (acetone, or the like), and preparation of slurry is extremely difficult because the settling velocity of the sulfide-based electrolyte is high in a low-polar solvent.

### SUMMARY OF INVENTION

The invention provides a manufacturing method for a solid electrolyte sheet, which is able to obtain a solid electrolyte sheet having a uniform thickness with a high lithium ion conductivity and also allows continuous production.

An aspect of the invention provides a manufacturing method for a solid electrolyte sheet. The manufacturing method includes applying slurry, which contains sulfide-based solid electrolyte powder, a sulfur-containing compound and a solvent, onto a base; and forming the slurry into a sheet.

In the above aspect, the sulfur-containing compound may be selected from the group consisting of a thiol expressed by R—SH and a sulfide expressed by R¹—S—R² where R, R¹ and R² each are a hydrocarbon group that may contain a heteroatom.

With the manufacturing method for a solid electrolyte sheet according to the aspect of the invention, it is possible to obtain a solid electrolyte sheet having a uniform thickness with a high lithium ion conductivity and also allows continuous production of the solid electrolyte sheet.

### BRIEF DESCRIPTION OF DRAWINGS

The features, advantages, and technical and industrial significance of this invention will be described below with reference to the accompanying drawings, in which like numerals denote like elements, and wherein:

FIG. 1 is a view that shows a manufacturing process of a solid electrolyte sheet according to an embodiment of the invention.

### DETAILED DESCRIPTION OF EMBODIMENTS

The inventors found that a sulfide-based solid electrolyte having a high lithium ion conductivity exhibits excellent dispersibility even in a low-polar solvent in the presence of a sulfur-containing compound and a homogeneous solid electrolyte sheet may be continuously produced by a method of applying slurry, which contains the sulfide-based solid electrolyte, the sulfur-containing compound and a solvent, onto a base.

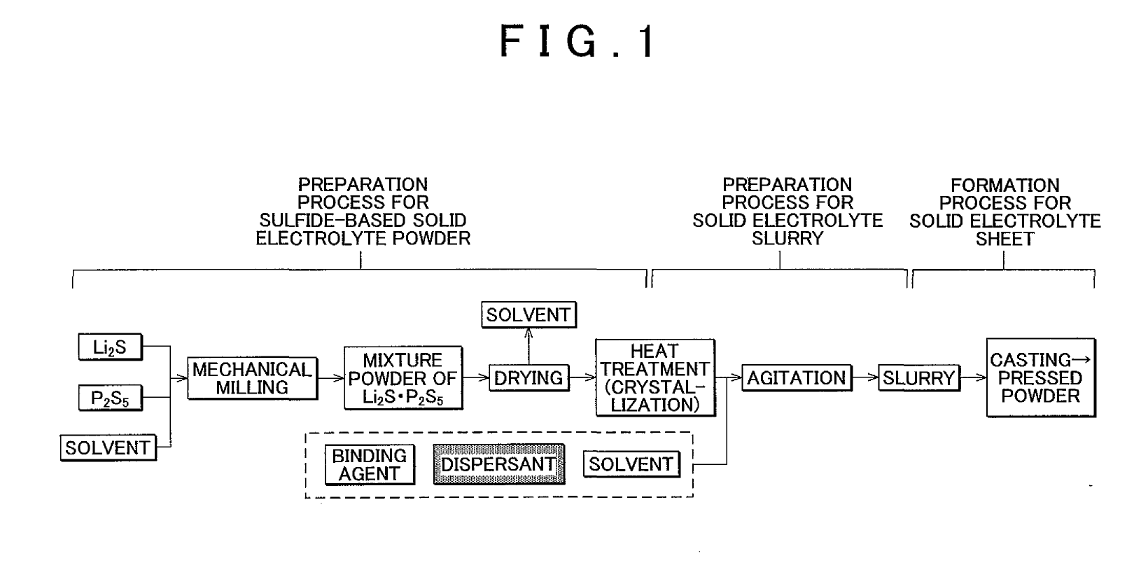

A manufacturing method for a solid electrolyte sheet according to an embodiment of the invention is able to continuously produce a solid electrolyte sheet by applying stable electrolyte slurry onto a base. The manufacturing method uses a sulfide-based solid electrolyte having a high lithium ion conductivity as a solid electrolyte and uniformly disperses the sulfide-based solid electrolyte in slurry because of the sulfur-containing compound specified in the embodiment of the invention to thereby make it possible to form a homogeneous sheet. Thus, the obtained solid electrolyte sheet has a uniform thickness and exhibits excellent lithium ion conductivity. Specifically, a solid electrolyte sheet is obtained in accordance with a manufacturing process for a solid electrolyte sheet, shown in FIG. 1.

### (1) Preparation Process for Sulfide-based Solid Electrolyte Powder

Hereinafter, a preparation process for sulfide-based solid electrolyte powder according to the embodiment of the invention will be described. In the embodiment of the invention, the sulfide-based solid electrolyte powder may be a vitreous solid lithium ion conducting electrolyte material that contains a sulfide as a major component and that can precipitate a metastable crystal through heat treatment. Specifically, for example, the vitreous solid lithium ion conducting electrolyte material may be an Li₂S—SiS₂-based material, an Li₂S—P₂S₅-based material, an Li₂S—B₂S₃-based material, an Li₂S—GeS₂-based material, an Li₂S—Sb₂S₃-based material, an Li₂S—ZrSₓ-based material, an Li₂S—FeSₓ-based material, an Li₂S—ZnSₓ-based material, or the like. In the above exemplified sulfide-based solid electrolyte materials, the ratio of lithium sulfide (Li₂S) to the other sulfide (SiS₂, P₂S₅, B₂S₃, GeS₂, Sb₂S₃, ZrSₓ, FeSₓ, ZnSₓ, or the like) is not specifically limited; however, the mole ratio of Li₂S to the other sulfide (Li₂S:the other sulfide) desirably ranges from 50:50 to 95:5.

The shape, size, and the like, of the sulfide-based solid electrolyte powder is not specifically limited; however, the primary particle diameter desirably ranges from 0.1 to 100 μm, particularly desirably ranges from 0.1 to 10 μm, and further desirably ranges from 0.5 to 5 μm. Here, the primary particle diameter of the sulfide-based solid electrolyte powder may be, for example, measured on the basis of image analysis using an electron microscope, such as an SEM.

The sulfide-based solid electrolyte powder may be, for example, obtained in such a manner that a glass material mixture that is a mixture of at least one selected from sulfur compounds, such as silicon sulfide (SiS₂), phosphorus pentasulfide (P₂S₅), boron sulfide (B₂S₃), germanium sulfide (GeS₂) and antimony sulfide (Sb₂S₃), and lithium sulfide (Li₂S) at a predetermined preparation ratio is subjected to mechanical milling or melt quenching to be vitrified. In view of simplification of the manufacturing process, a vitrification method is desirably mechanical milling. Here, mechanical milling will be specifically described. Note that melt quenching is a general glass synthesis method and may conform to a general method even when melt quenching is employed as a synthesis method for sulfide-based solid electrolyte powder.

Mechanical milling is a method of obtaining a glass material in such a manner that the raw material of a glass material is mechanically mixed and milled to be vitrified. Specific mechanical milling may be, for example, ball mill, turbo mill, mechanofusion, disk mill, or the like. Among others, ball mill is desirable, and planetary ball mill is particularly desirable. Mechanical milling is desirably performed in an inert atmosphere of nitrogen gas, or the like, in order to prevent reaction between the raw material of sulfide-based solid electrolyte powder and oxygen, vapor, or the like. A specific condition for mechanical milling may be appropriately set in accordance with an employed mechanical milling method, or the like. For example, when planetary ball mill is employed, the rotational speed desirably ranges from 50 to 500 rpm and particularly desirably ranges from 100 to 300 rpm.

Mechanical milling is desirably performed in the presence of a solvent. That is, a mixture of the raw material of sulfide-based solid electrolyte powder and a solvent is desirably subjected to mechanical milling. This is because aggregation of fine particles is suppressed to make it possible to obtain sulfide-based glass particles having a uniform particle diameter. In addition, this also effectively suppresses adhesion of fine particles to a case.

A solvent used in mechanical milling is not specifically limited as long as it does not react with sulfide-based solid electrolyte powder at a treatment temperature; however, a nonpolar solvent is desirable in terms of non-reactivity or low reactivity with a sulfide-based solid electrolyte. Note that, in the embodiment of the invention, the nonpolar solvent has an SP value of 21 (MJ/m³)^{1/2} or below and does not contain a reactive functional group, such as a ketone group, a carbonyl group and an amine group. A specific example of the nonpolar solvent may be, for example, a saturated hydrocarbon-based solvent, such as n-heptane, n-octane, n-nonane, n-decane, cyclohexane and cycloheptane, a fluorine-based resin, such as Vertrel (trademark, DU PONT-MITSUI FLUOROCHEMICALS COMPANY, LTD.), ZEORORA (trademark, ZEON CORPORATION) and NOVEC (trademark, Sumitomo 3M Limited), or a nonaqueous organic solvent, such as dichloromethane and diethyl ether. Other than the above, as long as a solvent does not react with sulfide-based solid electrolyte powder, a fluorine compound-based solvent, and the like, may also be used. The amount of solvent may be appropriately determined on the basis of a mechanical milling method, a ball diameter used when ball mill is employed, the size of a case, and the like. Generally, the amount of solvent is desirably set so that the vol % (volume percent) of the solid content of a mixture subjected to mechanical milling, that is, [{Solid Content/(Solid Content+Solvent)}×100], ranges from 30 to 70% and particularly ranges from 30 to 50%. In addition, it is required to leave a space substantially equivalent to the volume of the solvent inside the case.

A lithium ortho-oxosalt, such as Li₃PO₄, Li₄SiO₄, Li₄GeO₄, Li₃BO₃ and Li₃AlO₄, may be added to the glass raw material mixture that will be subjected to mechanical milling. By adding such a lithium ortho-oxosalt, glass in the obtained sulfide-based solid electrolyte powder may be stabilized. In addition, before mechanical milling, the glass raw material other than the solvent is desirably preliminary mixed and/or crushed in advance. Specific method, condition, and the like, for preliminary mixing or crushing are not specifically limited, and may be, for example, a typical method, such as using a mortar. Preliminary mixing or crushing is also desirably performed in an inert atmosphere from the same point of view as described above.

The sulfide-based solid electrolyte powder may be vitreous or may be partially or entirely crystallized; however, generally, partially crystallized sulfide-based solid electrolyte powder is used. Generally, glass has a sparse structure having a poor lattice arrangement and many voids as compared with crystal, and is considered to be advantageous in migration of ions, so it is expected that the crystal is vitrified to improve ion conductivity. However, it is known that the crystal of the material of sulfide-based glass, or the like, has a high temperature stable phase that exhibits extremely high ion conductivity at high temperatures, and the high temperature stable phase is considered to precipitate as a primary crystal when crystallized from glass.

The sulfide-based solid electrolyte powder may be crystallized in selected steps. For example, the sulfide-based solid electrolyte powder may be crystallized before being molded into a sheet or may be crystallized after or while being molded into a sheet. In a crystallization process for the sulfide-based solid electrolyte powder before being molded into a sheet, a glass raw material mixture (mixture of sulfide-based solid electrolyte powder and solvent) that has been subjected to mechanical milling is dried to remove the solvent and then the sulfide-based solid electrolyte powder is subjected to heat treatment to crystallize the sulfide-based solid electrolyte powder. A heating temperature in the crystallization process may be a temperature at which a high temperature stable phase may be precipitated from the sulfide-based solid electrolyte powder to be partially crystallized, that is, a temperature within the range of a crystallization temperature. The heating temperature may be appropriately determined on the basis of the type of sulfide-based solid electrolyte powder used. In the case of the above exemplified sulfide-based solid electrolyte powder, generally, the heating temperature ranges about 250 to 300° C., desirably ranges from 270 to 290° C. and particularly desirably ranges from 280 to 290° C. In a crystallization process for crystallizing the sulfide-based solid electrolyte powder after or while being molded into a sheet, for example, there is a method described in the paragraphs [0008] to [0010] in JP-A-2008-124011. Note that the crystallization temperature of the sulfide-based solid electrolyte powder may be observed by differential thermal analysis. In addition, partial crystallization of the sulfide-based solid electrolyte powder may be determined by X-ray crystal diffraction.

### (2) Preparation Process for Solid Electrolyte Slurry

Hereinafter, a process for preparing solid electrolyte slurry according to the embodiment of the invention using the sulfide-based solid electrolyte powder obtained in the above described process will be described. Specifically, a process for preparing slurry that contains the sulfide-based solid electrolyte powder, a sulfur-containing compound, a binding agent and a solvent will be described.

In the embodiment of the invention, the sulfur-containing compound is used as a dispersant for the sulfide-based solid electrolyte powder. The sulfur-containing compound is stable against the sulfide-based solid electrolyte powder, has a strong aggregate prevention function and has an affinity for an organic solvent. Therefore, the sulfur-containing compound serves as a dispersant for the sulfide-based solid electrolyte powder in the slurry, resulting in stabilization of the slurry (decrease in settling velocity of the sulfide-based solid electrolyte powder) in the organic solvent. Thus, a homogeneous sheet may be formed.

The sulfur-containing compound used in the embodiment of the invention is not specifically limited as long as the molecular structure has no polar group that reacts with a sulfide and the solubility to the solvent used ranges from 0.001 to 99 wt % and desirably ranges from 5 to 20 wt %. A specific example of the polar group that reacts with a sulfide may be a hydroxyl group, an amino group, a pyrrolidone group, a sulfoxide group, a ketone group, a carbonyl group, an amide group, a nitro group, a heterocyclic functional group, or the like. Thus, the sulfur-containing compound used in the embodiment of the invention desirably does not contain these groups.

In the embodiment of the invention, among the sulfur-containing compounds, an organic sulfur compound, such as a thiol expressed by the following formula (1), a sulfide expressed by the following formula (2) and a sulfone expressed by the following formula (3), is desirably used.

R—SH (1)

R¹—S—R² (2)

R³—SO₂—R⁴ (3)

R to R⁴ each represent a hydrocarbon group that may contain a heteroatom. Typically, the hydrocarbon group is a linear, branched or cyclic saturated hydrocarbon group, and, generally, the number of carbon atoms of R ranges from 3 to 20 and the number of carbon atoms of R¹ to R⁴ ranges from 1 to 5.

Among the organic sulfur compounds, the thiol and the sulfide are desirable in terms of a strong surface active effect and not causing a large decrease in ion conductivity of the sulfide-based solid electrolyte. The thiol may be any one of a monothiol having a single thiol group and a polythiol having two or more thiol groups. Specifically, the thiol may be a monothiol, such as 1-hexanethiol, 2,3-dimethyl-2-butanethiol, 2-methyl-2-pentanethiol, 2-methyl-3-pentanethiol, 2-ethyl-1-butanethiol, cyclohexanethiol, 1-methylcyclopentanethiol, 1-heptanethiol, 1-octanethiol, tert-octanethiol, 1-nonanethiol, tert-nonanethiol, 2,4,4,4-tetramethyl-3-pentanethiol, 1-decanethiol, 1-dodecanethiol, tert-dodecyl mercaptan, 1-tridecanethiol and 1-tetradecanethiol, or a polythiol, such as 1,6-hexanedithiol, 1,8-octanedithiol and toluene-3,4-dithiol. However, the thiol is not limited to these specific examples. The sulfide may be propyl sulfide, butyl sulfide, isobutyl sulfide, butyl propyl sulfide, hexyl sulfide or benzyl sulfide; however, the sulfide is not limited to these specific examples. Among others, the thiol of which R is a saturated hydrocarbon having the number of carbon atoms of 6 to 12, such as cyclohexanethiol, tert-octanethiol and tert-dodecyl mercaptan, is particularly desirable because it has a particularly strong surface active effect and may be volatilized to be removed finally. These sulfur-containing compounds may be used alone or in combination of two or more types.

The molecular weight of the sulfur-containing compound desirably ranges from 100 to 200,000, and more desirably ranges from 100 to 200. When the molecular weight of the sulfur-containing compound falls within the above range, the sulfur-containing compound has an adequate volatility, is easy to handle and is easily removed from the system.

The content of the sulfur-containing compound is not specifically limited as long as a solid electrolyte sheet having a desired dispersibility and an excellent lithium ion conductivity may be obtained. Specifically, the wt % (weight percent) of the weight of the sulfur-containing compound to the total weight of the sulfur-containing compound and the sulfide-based solid electrolyte powder [{Weight of Sulfur-containing Compound/(Weight of Sulfur-containing Compound+Weight of Sulfide-based Solid Electrolyte Powder)}×100] desirably ranges from 1 to 20 wt % and more desirably ranges from 5 to 15 wt %.

Generally, a binding agent is desirably added as another additive material in terms of flexibility, machinability, and the like, of a solid electrolyte sheet to be obtained. The binding agent is not specifically limited as long as it may be used as a material that binds sulfide-based solid lithium ion conducting electrolyte material used for an all-solid lithium ion secondary battery. For example, the binding agent may be a binding agent resin that contains at least one of Si, P and N, such as a silicon-based polymer and a phosphazene polymer, or a binding agent resin that does not contain unsaturated bond, such as polystyrene, polyethylene, ethylene-propylene polymer and styrene-butadiene polymer. As the molecular weight of the binding agent resin, for example, the number-average molecular weight desirably ranges from 1,000 to 10,000, particularly desirably ranges from 5,000 to 80,000 and more desirably ranges from 10,000 to 65,000. The content of the binding agent may be appropriately determined; however, because a solid electrolyte sheet having desired flexibility and machinability with an excellent ion conductivity may be obtained, the wt % (weight percent) of the weight of the binding agent to the total weight of the binding agent and the sulfide-based solid electrolyte powder [{Weight of Binding Agent/(Weight of Binding Agent+Weight of Sulfide-based Solid Electrolyte Powder)}×100] desirably ranges from 0.5 to 5%, particularly desirably ranges from 0.5 to 2% and more desirably ranges from 0.5 to 1.5%. Note that the binding agent resin may be mixed into slurry after being cured by a curing agent, or the like.

A solvent used for preparing slurry according to the invention may be the same solvent as the solvent used in mechanical milling in the preparation process for the sulfide-based solid electrolyte powder. In addition, liquid sulfur-containing compounds among the above described sulfur-containing compounds may be used as a solvent for preparing slurry. The amount of the solvent in slurry may be appropriately determined. Specifically, for example, where the total weight of the sulfide-based solid electrolyte powder, the sulfur-containing compound and the binding agent is defined as 100 parts by weight, the amount of the solvent desirably ranges from 20 to 300 parts by weight, and particularly desirably ranges from 50 to 250 parts by weight.

A method of preparing slurry using the sulfide-based solid electrolyte powder, the sulfur-containing compound and the solvent is not specifically limited. The slurry may be prepared by mixing and agitating these sulfide-based solid electrolyte powder, sulfur-containing compound and solvent. Note that another material, such as a binding agent, may be added to slurry other than the sulfide-based solid electrolyte powder, the sulfur-containing compound or the solvent.

### (3) Formation Process for Solid Electrolyte Sheet

Hereinafter, a process in which the slurry of the sulfide-based solid electrolyte powder obtained in the above process is applied onto a base and is formed into a sheet will be described. Note that the “sheet” in the embodiment of the invention means a pressed powder thin film having a thickness of 0.1 to 100 μm and particularly a thickness of 1 to 50 μm.

The solid electrolyte sheet according to the embodiment of the invention is formed in such a manner that the slurry of the sulfide-based solid electrolyte powder is applied onto a substrate and then dried. A method of applying slurry and a method of drying slurry are not specifically limited. The lithium ion conductivity of the solid electrolyte sheet is desirably improved in such a manner that pressure is exerted on the obtained solid electrolyte sheet to decrease the voidage of the sheet to thereby increase the contact area among the particles of the sulfide-based solid electrolyte powder in the solid electrolyte sheet. A method of exerting pressure on the solid electrolyte sheet, exerted pressure, and the like, are not specifically limited, and a general pressure device may be used. In addition, as described above, in the manufacturing method for a solid electrolyte sheet according to the embodiment of the invention, the sulfide-based solid electrolyte may be crystallized by heat treatment after the sheet has been formed.

A base material, that is, a base, onto which the slurry is applied may be, for example, not only a metal foil, a resin sheet, or the like, but also an electrode layer sheet that constitutes an electrode layer of an all-solid lithium secondary battery. When a metal foil, a resin sheet, or the like, is used as the base material, a solid electrolyte sheet may be obtained by peeling the base material.

The solid electrolyte sheet obtained in the embodiment of the invention contains a sulfur-containing compound as a dispersant for the sulfide-based solid electrolyte powder to thereby obtain a homogeneous solid electrolyte sheet having a high ion conductivity. Note that in the embodiment of the invention, a method of forming the solid electrolyte sheet and the shape of the solid electrolyte sheet are not limited to the above.

Hereinafter, unless otherwise specified, all work was carried out in an Ar gas filled glove box, used solvents and dispersants all were dewatered by still standing for 48 hours using a molecular sieve, and used tools and samples all were degreased by acetone multiple times before using and then were dried in a vacuum at 120° C. for 24 hours.

### First Example

5.60 g of lithium sulfide (purity 99.9%) and 2.40 g of phosphorus pentasulfide (purity 99%, produced by Aldrich) were premixed in an agate mortar, then 12 g of n-heptane (produced by Nacalai Tesque) was added as a solvent, and then the materials were mixed at a rotational speed of 300 rpm for 15 hours by a planetary ball mill (50 ml case made of zirconia, ball diameter of 2 mm, produced by Fritsch Company). The obtained mixture (electrolyte) was simply dried on a Kiriyama funnel filter paper, filled into a pressure case made of SUS, and heated to 290° C. by a mantle heater for 2 hours. By so doing, the solvent was removed and the sulfide-based solid electrolyte powder was crystallized to obtain coarse electrolyte powder. The obtained electrolyte powder was lightly crushed to be uniform in a mortar, 7.00 g of n-heptane was added to the 2.67 g of electrolyte, then 0.30 g (0.35 ml) of tert-dodecyl mercaptan (produced by Tokyo Chemical Industry Co., Ltd) was further added to the electrolyte by a microsyringe while agitating, and then the electrolyte was agitated for an hour. After agitation, it is assumed that the settling velocity of the electrolyte slurry is equal to the lowering speed of a slurry clear surface, the lowering speed was visually measured in a micro pipette, and then the mean settling velocity of 9.87×10−5 mm/s was obtained. In addition, 0.03 g of SBR (styrene-butadiene) resin was dissolved into the electrolyte slurry, the resultant electrolyte slurry was applied and deposited onto a SUS foil by a doctor blade (gap interval of 120 μm) and then dried at 120° C. for an hour. The thickness of the obtained electrolyte membrane was measured by a micrometer (produced by Mitutoyo Corporation) to obtain the mean thickness of 68 μm. The electrolyte membrane was compacted by a roll press (produced by Takumi Giken, having a roll gap of 30 μm), and then the uniform electrolyte membrane having a thickness of 36 μm was obtained. The lithium ion conductivity (at 0.1 MHz) of the compacted electrolyte membrane was measured using a frequency response analyzer (FRA) (produced by Solartron, 1260 type). The results are shown in Table 1.

### Second Example

A second example differs from the first example in that 7.00 g (7.21 ml) of tert-dodecyl mercaptan (produced by Tokyo Chemical Industry Co., Ltd) was used as the solvent used at the time of slurry preparation, and then the settling velocity of the electrolyte slurry was measured. In addition, as in the case of the first example, the compacted electrolyte membrane was prepared, and the lithium ion conductivity was measured. The results are shown in Table 1.

### Third Example

0.30 g (0.32 ml) of cyclohexanethiol (produced by Tokyo Chemical Industry Co., Ltd) was used as the sulfur-containing compound (dispersant), and the settling velocity of the electrolyte slurry was measured under the same condition as the first example except that the drying temperature during deposition was set at 150° C. In addition, as in the case of the first example, the compacted electrolyte membrane was prepared, and the lithium ion conductivity was measured. The results are shown in Table 1.

### Fourth Example

A fourth example differs from the first example in that 0.30 g (0.36 ml) of tert-octanethiol (produced by Tokyo Chemical Industry Co., Ltd) was used as the sulfur-containing compound (dispersant), and then the settling velocity of the electrolyte slurry was measured. In addition, as in the case of the first example, the compacted electrolyte membrane was prepared, and the lithium ion conductivity was measured. The results are shown in Table 1.

### Fifth Example

A fifth example differs from the first example in that 0.30 g (0.36 ml) of propyl sulfide (produced by Tokyo Chemical Industry Co., Ltd) was used as the sulfur-containing compound (dispersant), and then the settling velocity of the electrolyte slurry was measured. In addition, as in the case of the first example, the compacted electrolyte membrane was prepared, and the lithium ion conductivity was measured. The results are shown in Table 1.

### Sixth Example

A sixth example differs from the first example in that 0.30 g (0.36 ml) of iso-butyl sulfide (produced by Tokyo Chemical Industry Co., Ltd) was used as the sulfur-containing compound (dispersant), and then the settling velocity of the electrolyte slurry was measured. In addition, as in the case of the first example, the compacted electrolyte membrane was prepared, and the lithium ion conductivity was measured. The results are shown in Table 1.

### First Comparative Example

A first comparative example differs from the first example in that no sulfur-containing compound (dispersant) was used, and then the settling velocity of the electrolyte slurry was measured. In addition, as in the case of the first example, the compacted electrolyte membrane was prepared, and the lithium ion conductivity was measured. The results are shown in Table 1.

### Second Comparative Example

A second comparative example differs from the first example in that no sulfur-containing compound was used as a dispersant but 0.30 g (0.37 ml) of 1-pentanol (produced by Tokyo Chemical Industry Co., Ltd) was used, and then the settling velocity of the electrolyte slurry was measured. In addition, as in the case of the first example, the compacted electrolyte membrane was prepared, and the lithium ion conductivity was measured. The results are shown in Table 1.

### Third Comparative Example

A third comparative example differs from the first example in that no sulfur-containing compound was used as a dispersant but 0.30 g (0.27 ml) of Triton X-100 (produced by Nacalai Tesque) was used, and then the settling velocity of the electrolyte slurry was measured. In addition, as in the case of the first example, the compacted electrolyte membrane was prepared, and the lithium ion conductivity was measured. The results are shown in Table 1.

TABLE 1

| | Solvent Used | | Drying | Settling | Lithium Ion |
|---|---|---|---|---|---|
| | for Slurry | | Temperature | Velocity | Conductivity |
| | Preparation | Dispersant | [° C.] | [mm/s] | [S/cm] |
| First | n-heptane | tert-dodecyl | 120° C. | 9.87 × 10⁻⁵ | 9.54 × 10⁻⁴ |
| Example | | mercaptan | | | |
| Second | tert-dodecyl | tert-dodecyl | 120° C. | 4.30 × 10⁻⁵ | 9.44 × 10⁻⁴ |
| Example | mercaptan | mercaptan | | | |
| Third | n-heptane | Cyclohexanethiol | 150° C. | 9.87 × 10⁻⁵ | 8.99 × 10⁻⁴ |
| Example | | | | | |
| Fourth | n-heptane | tert-octanethiol | 120° C. | 8.92 × 10⁻⁵ | 9.11 × 10⁻⁴ |
| Example | | | | | |
| Fifth | n-heptane | propyl sulfide | 120° C. | 1.92 × 10⁻⁴ | 7.67 × 10⁻⁴ |
| Example | | | | | |
| Sixth | n-heptane | isobutyl sulfide | 120° C. | 1.01 × 10⁻⁴ | 9.91 × 10⁻⁴ |
| Example | | | | | |
| First | n-heptane | — | 120° C. | 9.30 × 10⁻¹ | 1.01 × 10⁻³ |
| Comparative | | | | | |
| Example | | | | | |
| Second | n-heptane | 1-pentanol | 120° C. | 5.30 × 10⁻⁴ | 1.01 × 10⁻⁷ |
| Comparative | | | | | |
| Example | | | | | |
| Third | n-heptane | Triton X-100 | 120° C. | 3.30 × 10⁻⁶ | 8.98 × 10⁻⁷ |
| Comparative | | | | | |
| Example | | | | | |

### Results

The following facts are found from the evaluation results shown in Table 1. In the first comparative example, because the sulfur-containing compound that is specified as a dispersant for the sulfide-based solid electrolyte in the embodiment of the invention was not used, the lithium ion conductivity of the obtained solid electrolyte sheet was high; however, the settling velocity of the sulfide-based solid electrolyte powder in the shiny was high, so the electrolyte slurry had poor stability. In addition, the solid electrolyte sheet obtained in the first comparative example already had a nonuniform thickness before drying, and also had a nonuniform thickness after roll press.

In the second comparative example, because the sulfur-containing compound that is specified as a dispersant for the sulfide-based solid electrolyte powder in the embodiment of the invention was not used but 1-pentanol was used, the lithium ion conductivity of the obtained solid electrolyte sheet was low. The settling velocity of the sulfide-based solid electrolyte powder in the slurry was relatively low; however, the phase was separated, and the solid electrolyte sheet had a nonuniform thickness. In addition, at the time of dripping the dispersant, gas was generated from the slurry, and then the electrolyte was discolored.

In the third comparative example, because the sulfur-containing compound that is specified as a dispersant for the sulfide-based solid electrolyte powder in the embodiment of the invention was not used but Triton X-100 (produced by Nacalai Tesque), which is a commercially available nonionic surface active agent, was used, the lithium ion conductivity of the obtained solid electrolyte sheet was low. The settling velocity of the sulfide-based solid electrolyte in the slurry was relatively low; however, the slurry was discolored, and the solid electrolyte sheet had a nonuniform thickness. In addition, at the time of dripping the dispersant, gas was generated from the slurry, and the slurry was heated.

In the first to sixth examples, the slurry had no phase separation and discoloring, and no generation of gas, heat, or the like, occurs at the time of dripping the dispersant into the slurry. Thus, the stable slurry having a low settling velocity of the sulfide-based solid electrolyte was prepared, and the homogeneous thin-film solid electrolyte sheet was obtained. In addition, the lithium ion conductivity of the obtained solid electrolyte sheet was sufficiently high. Thus, it is found that the homogeneous solid electrolyte sheet having a high ion conductivity may be obtained by the method of applying slurry, which contains the sulfide-based solid electrolyte powder, the sulfur-containing compound specified as the dispersant for the sulfide-based solid electrolyte powder in the embodiment of the invention and the solvent, onto the base and forming the slurry into a sheet.

What is claimed is:

1. A manufacturing method for a solid electrolyte sheet, comprising:
applying slurry, which contains sulfide-based solid electrolyte powder, a sulfur-containing compound and a solvent, onto a base; and
forming the slurry into a sheet.

2. The manufacturing method for a solid electrolyte sheet according to claim 1, wherein the sulfur-containing compound is selected from the group consisting of a thiol expressed by R—SH and a sulfide expressed by R¹—S—R² where R, R¹ and R² each are a hydrocarbon group that may contain a heteroatom.

3. The manufacturing method for a solid electrolyte sheet according to claim 1, wherein the sulfide-based solid electrolyte powder is a vitreous solid lithium ion conducting electrolyte material.

4. The manufacturing method for a solid electrolyte sheet according to claim 1, wherein the sulfide-based solid electrolyte powder is composed of Li₂S and a sulfide other than the Li₂S, and the mole ratio between the Li₂S and the other sulfide ranges from 50:50 to 95:5.

5. The manufacturing method for a solid electrolyte sheet according to claim 1, wherein the primary particle diameter of the sulfide-based solid electrolyte powder ranges from 0.5 to 5 μm.

6. The manufacturing method for a solid electrolyte sheet according to claim 1, further comprising:
drying a mixture of the sulfide-based solid electrolyte powder and the solvent and then subjecting the sulfide-based solid electrolyte powder to heat treatment.

7. The manufacturing method for a solid electrolyte sheet according to claim 1, wherein the molecular structure of the sulfur-containing compound has no polar group that reacts with a sulfide, and the solubility of the sulfur-containing compound to the solvent ranges from 5 to 20 wt %.

8. The manufacturing method for a solid electrolyte sheet according to claim 1, wherein the sulfur-containing compound is any one of cyclohexanethiol, tert-octanethiol and tert-dodecyl mercaptan.

9. The manufacturing method for a solid electrolyte sheet according to claim 1, wherein the molecular weight of the sulfur-containing compound ranges from 100 to 200.

10. The manufacturing method for a solid electrolyte sheet according to claim 1, wherein the weight ratio of the weight of the sulfur-containing compound to the total weight of the sulfur-containing compound and the sulfide-based solid electrolyte powder ranges from 5 to 15 wt %.

11. The manufacturing method for a solid electrolyte sheet according to claim 1, further comprising:
adding a binding agent to the slurry.

12. The manufacturing method for a solid electrolyte sheet according to claim 11, wherein the binding agent is any one of polystyrene, polyethylene, ethylene-propylene polymer and styrene-butadiene polymer.

13. The manufacturing method for a solid electrolyte sheet according to claim 11, wherein the amount of the solvent in the slurry ranges from 50 to 250 parts by weight where the total weight of the sulfide-based solid electrolyte powder, the sulfur-containing compound and the binding agent is defined as 100 parts by weight.

14. The manufacturing method for a solid electrolyte sheet according to claim 1, further comprising:
exerting pressure on the slurry formed in the sheet.
